(19) United States
(12) Patent Application Publication
(10) Pub. No.: US 2024/0088755 A1
(43) Pub. Date: Mar. 14, 2024

(54) ELECTRICAL MACHINE AND METHOD FOR CLEANING AN AIR GAP IN AN ELECTRICAL MACHINE

(71) Applicant: Rolls-Royce Deutschland Ltd & Co KG, Blankenfelde-Mahlow (DE)

(72) Inventors: Frederic PFLAUM, Erlangen (DE); Pascal KOLEM, Blankenfelde-Mahlow (DE); Philipp SCHILDT, Hirschaid (DE); Anton DILCHER, Blankenfelde-Mahlow (DE)

(21) Appl. No.: 18/274,363

(22) PCT Filed: Jan. 21, 2022
(86) PCT No.: PCT/EP2022/051363

§ 371 Date: Jul. 26, 2023

(30) Foreign Application Priority Data
Jan. 28, 2021 (DE) 10 2021 101 937.0

(51) Int. Cl. H02K 9/26; H02K 1/32

(52) U.S. Cl. CPC H02K 9/26; H02K 1/32; H02K 2201/03

(57) ABSTRACT

The disclosure relates to an electrical machine that includes: a stator that forms a cylindrical inner face; a rotor configured to rotate inside the stator about a longitudinal axis that defines an axial direction, the rotor forming a cylindrical outer face; and an air gap formed between the cylindrical outer face of the rotor and the cylindrical inner face of the stator. Apparatuses and mechanisms are provided for providing an air flow in the air gap, wherein the air flow flows in and/or counter to the axial direction in the air gap. The disclosure also relates to methods for cleaning an air gap in an electrical machine.

The present patent document is a § 371 nationalization of PCT Application Serial No. PCT/EP2022/051363, filed Jan. 21, 2022, designating the United States, and this patent document also claims the benefit of German Patent Application No. 10 2021 101 937.0, filed Jan. 28, 2021, which are incorporated by reference in their entireties.

### TECHNICAL FIELD

The disclosure relates to an electrical machine and to a method for cleaning an air gap in an electrical machine.

### BACKGROUND

Electrical machines have a rotor and a stator. There is an air gap between the rotor and the stator, and the air gap may become contaminated, for example, with free-flying particles. To avoid contamination of the air gap, it is known to completely encapsulate the electrical machine. However, this leads to additional heating of the electrical machine.

### SUMMARY AND DESCRIPTION

The disclosure is based on the object of avoiding or at least reducing contamination of the air gap between the rotor and stator in electrical machines.

The scope of the present disclosure is defined solely by the appended claims and is not affected to any degree by the statements within this summary. The present embodiments may obviate one or more of the drawbacks or limitations in the related art.

Accordingly, the present disclosure concerns an electrical machine that includes a stator and a rotor. The stator forms a cylindrical inner surface. The rotor rotates inside the stator about a longitudinal axis, which defines an axial direction, and forms a cylindrical outer surface. An air gap is formed between the cylindrical outer surface of the rotor and the cylindrical inner surface of the stator.

Apparatuses or mechanisms for providing an air flow in the air gap are disclosed, wherein the air flow flows in and/or counter to the axial direction in the air gap.

The disclosure is based on the idea of cleaning the air gap between the rotor and stator and keeping the air gap free of contamination by providing an air flow. The air gap between the rotor and stator is actively blown clear by the generated air flow.

In addition to cleaning the air gap, the disclosure has the further advantage that cooling of the rotor is provided by the air flow. The advantages mentioned lead to an increase in the performance of an electrical machine due to improved cooling and a lower susceptibility to dirt.

The air flow introduced into the air gap flows in and/or counter to the axial direction in the air gap. The axial direction is defined by the longitudinal axis of the rotor and its direction of rotation in accordance with the right-hand rule. The direction of the air flow in the air gap depends in particular on the axial position at which the air flow is introduced in the air gap. When this occurs in a mid-axial position, the air flow may split into a component that flows in the axial direction and a component that flows counter to the axial direction. If the air flow is introduced at the start or at the end of the air gap, the air flow will either flow in the axial direction or flow counter to the axial direction in the air gap.

In one refinement, the electrical machine is intended and configured to provide an air flow when the rotor is rotating, wherein air is introduced and accelerated by rotation of the rotor into the air gap, and wherein air introduced into the air gap flows in and/or counter to the axial direction in the air gap.

This aspect is based on the idea of utilizing the rotation of the rotor in order to generate an air flow that cleans the air gap between the rotor and stator or keeps the air gap free of contamination. The effect according to the disclosure is based on the principle of a radial centrifugal pump utilizing centrifugal force. Air located in the rotor is carried to the outside on a spiral path by rotation of the rotor, accelerated in the radial direction in the process, and introduced into the air gap. Air then flows in and/or counter to the axial direction in the air gap. This refinement does not require any additional components for generating an air flow.

In one refinement, the rotor forms an air duct which extends in the radial direction and provides the air flow and forms the mechanism or apparatus, wherein the air duct extends from a rotor shaft of the rotor in the radial direction and at its radial outer end ends in the air gap, so that air flows into the air gap via the radially outer end of the air duct when the rotor is rotating. Since the air, when the air flows into the air gap, has an overpressure at the point of inflow compared to the surrounding area, the air may flow both in and against the axial direction in the air gap.

Various variants are possible in terms of how air that is accelerated in the air duct when the rotor is rotating may flow into the air duct. In a first design variant in this respect, the air duct has an air supply adjacent to the shaft (e.g., directly adjacent to the rotor shaft or at a radial distance from the rotor shaft that is less than 50% of the radial length of the air duct). The air supply is provided by at least one opening in the air duct to the surrounding area. When the air located in the air duct is accelerated in the radial direction by centrifugal force, air flowing in afterward is drawn into the air duct through this at least one opening when the rotor is rotating.

In a second design variant for an inflow of air into the air duct, the rotor shaft is designed as a hollow shaft. It is further provided that the hollow shaft is connected to the air duct via at least one opening. The air flow for the air duct is provided by air which flows from the hollow shaft into the air duct and from there into the air gap.

In further design variants, air is introduced into the air duct by an external pump. For example, in the abovementioned exemplary embodiment, an external pressure is applied to the hollow shaft. In this design variant, an air flow is provided in the air gap independently of rotation of the rotor.

In one refinement, the air duct is provided by two radially oriented plates which are spaced apart in the axial direction. Both plates are connected in a rotationally fixed manner to the rotor shaft. The air gap is formed between the two plates.

The air duct may be formed in any structure of the rotor. If the rotor is designed as a solid cylinder, the air duct is provided, for example, by radial structures in the solid cylinder. In one refinement, in which the rotor has a lightweight design, the air duct is formed in a support structure that extends radially from the rotor shaft and serves to fasten surface permanent magnets to the rotor at a radial distance from the rotor shaft.

The support structure includes, at a radially outer end of the support structure that is remote from the rotor shaft, at least one receiving surface for receiving at least one external permanent magnet. The external permanent magnet or magnets forms/form the outer surface or is/are part of the outer surface of the rotor here.

In such a refinement, the support structure may be of T-shaped design in a longitudinal section.

The air duct, in which air is accelerated in the radial direction when the rotor is rotating and which ends in the air gap between the rotor and the stator, may be continuous or interrupted in the circumferential direction. For example, the air gap may include different sectors in the circumferential direction. When the rotor is embodied as a solid cylinder, a plurality of cooling air ducts may be provided, wherein the cooling air ducts are spaced apart in the circumferential direction and each extend in the radial direction as far as the air gap.

In a further refinement, elements for conveying air that promote radial transportation of the air are arranged in the air duct. These elements may be, for example, lamellae or blades as in a radial impeller or may be vortex-generating elements.

In a further refinement, the air duct ends in the center of the air gap in relation to the axial extent of the air gap. This provides that incoming air flows in the same way in the axial direction and counter to the axial direction in the air gap and actively blows it clear over its entire length. In order to reinforce this, the cylindrical inner surface of the stator may form a structure that is wedge-shaped in cross section in the region in which air exiting from the air duct extending in the radial direction strikes the stator and which deflects a portion of the air axially forward and a portion of the air axially backward.

According to a further design variant, a seal is provided axially in front of the air gap and/or axially behind the air gap, wherein the seal is configured to seal off the air gap against contaminants. The seal may be a mechanical seal, a labyrinth seal, or a brush seal. Depending on the configuration of the seal, the seal includes elements which extend radially inward starting from the stator and in the process protrude radially inward over the air gap.

Additional protection for the air gap between the rotor and the stator by a seal leads to further prevention of contamination of the air gap. The seal protects the air gap in particular from particles flying in the axial direction.

The electrical machine may be an electric motor, e.g., a permanent-magnet synchronous motor. In a permanent synchronous motor, the stator is equipped with coils, while external surface magnets are attached to the rotor. The AC voltage is applied to the stator coils.

According to a further aspect, a method for cleaning an air gap in an electrical machine is disclosed, wherein the air gap extends between a cylindrical inner surface of a stator and a cylindrical outer surface of a rotor of the electrical machine. The method includes: air being accelerated in the radial direction by rotation of the rotor, the air flowing into the air gap, and the air flowing in and/or counter to an axial direction of the rotor in the air gap.

The air may be accelerated in an air duct that extends in the rotor in the radial direction and ends in the air gap.

### BRIEF DESCRIPTION OF THE DRAWINGS

The disclosure is explained in more detail below on the basis of a plurality of exemplary embodiments with reference to the figures of the drawing, in which:

FIG. 1 depicts a longitudinal section through an exemplary embodiment of an electric motor that includes a rotor and a stator, between which an air gap is formed, wherein the rotor forms an air duct extending in the radial direction and the air duct forms openings close to the shaft for the entry of an air flow; and

FIG. 2 depicts a longitudinal section through a further exemplary embodiment of an electric motor that includes a rotor and a stator, between which an air gap is formed, wherein the rotor forms an air duct extending in the radial direction and the air duct has an opening to a hollow shaft of the rotor for the entry of an air flow through the hollow shaft.

### DETAILED DESCRIPTION

The electrical machine considered below is an electric motor. However, the principles of the present disclosure may equally be applied to an electrical generator.

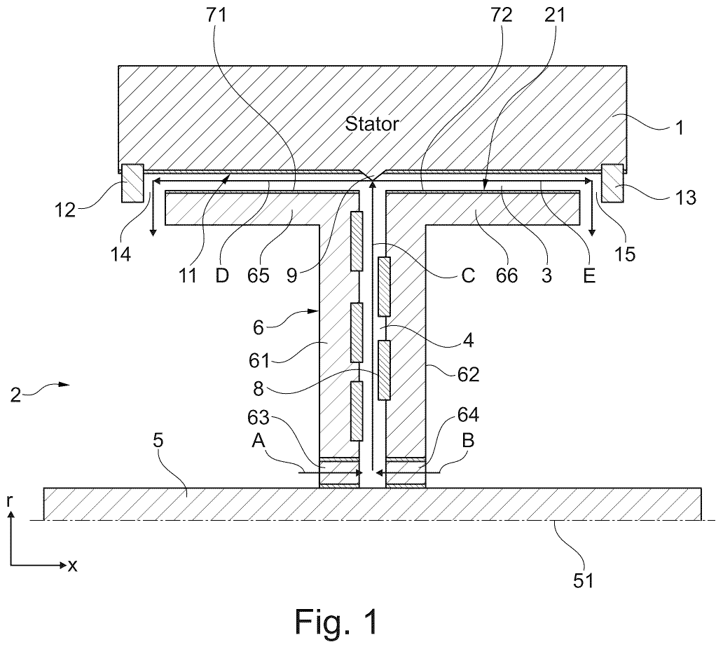

According to FIG. 1, the electric motor has a stator 1 and a rotor 2. The stator 1 is shown only schematically and includes a plurality of coils (not shown) in a manner known per se. The rotor 2 is arranged on the inside of the stator 1 and rotates about a longitudinal axis 51, which defines an axial direction x. The rotor is an internal rotor 2 that is configured to rotate within the stator 1 surrounding the rotor 2.

The stator 1 includes a cylindrical inner surface 11. The rotor 2 includes a cylindrical outer surface 21. An air gap 3 is formed between the cylindrical inner surface 11 of the stator 1 and the cylindrical outer surface 21 of the rotor 2, the air gap being shown only schematically and not to scale. The air gap 3 is a radial air gap, i.e., the air gap is defined by the radial distance between the outer surface 21 and the inner surface 11. At the same time, the air gap has a longitudinal extent in the axial direction x.

The rotor 2 includes a rotor shaft 5 which rotates about the longitudinal axis 51. An air duct 4 extends from the rotor shaft 5 in the radial direction and at its radially outer end ends in the air gap 3. At the point at which the air duct 4 ends in the air gap 3, a wedge-shaped structure 9 is formed on the stator 1. The wedge-shaped structure includes two inclined surfaces, wherein each inclined surface forms an acute angle, (e.g., a 45° or 60° angle), with respect to the cylindrical inner surface 11 of the stator 1.

The air duct 4 is formed in a support structure 6 that has a T-shaped structure in the longitudinal illustration of FIG. 1. The support structure 62 therefore includes axially spaced plates 61, 62, which are each oriented in the radial direction and between which the air duct 4 is formed. In the sectional illustration of FIG. 1, the plates 61, 62 appear to be in the form of a web.

At their radially outer end remote from the rotor shaft 5, the two plates 61, 62 or the support structure 6 each have a receiving surface 65, 66 extending in the axial direction. External surface magnets 71, 72, which are shown schematically and are formed by permanent magnets, are arranged on the outer surface of the receiving surfaces 65, 66. The surface magnets 5 are adhesively bonded to the receiving surfaces 65, 66, for example. The surface magnets 5 may be radially fixed by a bandage (not shown). Such a bandage is formed, for example, by a glass sleeve or a carbon fiber sleeve.

The surface magnets 71, 72, together with a bandage that may be present, form the cylindrical outer surface 71 of the rotor.

In an alternative refinement, the permanent magnets of the rotor may not designed as surface magnets, but as so-called buried magnets, which are held by the rotor lamination. In such a case, the cylindrical outer surface 71 of the rotor is formed, for example, by the rotor lamination.

A seal 12, 13 is provided both axially in front of and axially behind the air gap 3, the seals extending radially inward starting from the stator 1 and in the process protruding radially inward over the air gap 3 and thus covering it against axially flying particles. The seal 12, 13 may be a brush seal, a labyrinth seal, or a mechanical seal, for example. A gap 14, 15 is formed both between the axially front seal 12 and the receiving surface 65 and between the axially rear seal 13 and the receiving surface 66.

Air supplies, which are provided by openings 63, 64 in the plates 61, 62, are formed radially adjacent to the rotor shaft 5 in the radially extending air duct 4. Furthermore, a plurality of elements 8 for conveying air are arranged in the air duct 4. This plurality of elements may be a blading or lamellae through which air, (e.g., similarly to a radial pump), is transported radially to the outer peripheral region while providing an increase in pressure.

When the rotor 2 is rotating, an air flow is provided through the air duct 4, the air flow being introduced into the air gap 3 and flowing in the air gap 3 in the axial direction and counter to the axial direction. The manner of operation is as follows.

When the rotor 2 is rotating, the air in the air duct 4 experiences an acceleration in the radial direction due to centrifugal force on account of the elements 8 for conveying air (and additionally due to the air boundary layer adjoining the plates 61, 62 being entrained). The air is carried outward on a spiral path. In the process, the pressure to the outside increases on account of the action of centrifugal force. Accordingly, air is drawn radially inward via the openings 63, 64, so that two air streams A, B exist close to the shaft, air flowing into the air duct 4 via the air flows. In the air duct 4, as explained, the air flows radially outward in an air flow C (with the air performing a spiral movement). The air of the air flow C strikes the wedge-shaped structure 9 and splits into a flow D, which flows counter to the axial direction, and a flow E, which flows in the axial direction. The flows D, E result from the overpressure generated by the rotation of the rotor 2 here.

The air flows out of the air gap 3 in the gaps 14, 15 between the axially front seal 12 and the receiving surface 65 and, respectively, between the axially rear seal 13 and the receiving surface 66.

Owing to the rotation of the rotor 2 and the described construction, an air flow is therefore formed in the air gap 3, the air flow including the two partial air flows D, E and providing that the air gap 3 is blown clear, so that contamination of the air gap 3 is prevented. In addition, contamination of the air gap 3 is prevented by the two seals 12, 13, which, in particular, seal off the air gap 3 from particles flying in the axial direction.

In the sectional view of FIG. 1, only the upper half of the electric motor is shown. This is only done to improve clarity of the illustration. The lower half of the electric motor is designed in a corresponding manner, it being possible for the stator 1 and/or rotor 2 to be of rotationally symmetrical design.

The electric motor shown in FIG. 1 is also referred to as a permanent-magnet synchronous motor. During operation, an AC voltage is applied to the stator coils, this causing the stator coils to form a magnetic field when current is flowing, the magnetic field circulating continuously due to the three-phase nature of the current. A further magnetic field is formed by the surface magnets 71, 72 of the rotor 2.

The manner in which an air flow is provided when the rotor is rotating in FIG. 1 is to be understood merely by way of example. In principle, any constructions in which an air flow is generated due to rotation of the rotor or in some other way and introduced into the air gap 3 may be used in the present disclosure.

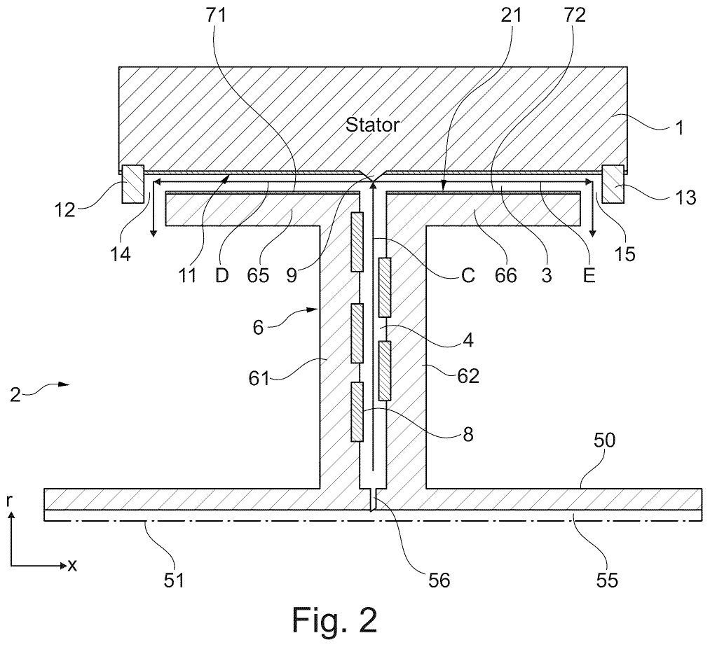

For this purpose, FIG. 2 shows an alternative construction that differs from the construction of FIG. 1 only in the features described below. In the exemplary embodiment of FIG. 2, the rotor shaft is designed as a hollow shaft 50 that forms an inner hollow cylinder 55. The hollow cylinder 55 is connected to the air duct 4 via an air line 56. When the hollow shaft 50 is rotating, air is drawn into the air duct 4 via the hollow cylinder 55 and the air line 56. Otherwise, the manner of operation and the structure correspond to the manner of operation and the structure of the exemplary embodiment of FIG. 2.

In a further refinement, the hollow cylinder 55 may be pressurized by an external pressure source. As a result, an air flow may also be generated through the air duct 4 and the air gap 3 when the rotor 2 is not rotating. When the rotor 2 is rotating, more air flow is provided.

Further refinements provide that an air flow is provided exclusively by an external pressure source.

It is understood that the disclosure is not limited to the embodiments described above, and various modifications and improvements may be made without departing from the concepts described herein. It should furthermore be noted that any of the features described may be used separately or in combination with any other features, provided that they are not mutually exclusive. The disclosure extends to and includes all combinations and sub-combinations of one or a plurality of features which are described here. If ranges are defined, the ranges therefore include all the values within the ranges as well as all the partial ranges that lie within a range.

1. An electrical machine comprising:
a stator having a cylindrical inner surface;
a rotor configured to rotate inside the stator about a longitudinal axis that defines an axial direction, wherein the rotor having a cylindrical outer surface; and
an air gap formed between the cylindrical outer surface of the rotor and the cylindrical inner surface of the stator,
wherein an air flow is configured to flow in the air gap, wherein the air flow flows in an axial direction and/or counter to the axial direction in the air gap.

2. The electrical machine of claim 1, wherein the electrical machine is configured to provide the air flow when the rotor is rotating,
wherein air introduced into the air gap is accelerated by rotation of the rotor into the air gap, and
wherein the air introduced into the air gap flows in the axial direction and/or counter to the axial direction in the air gap.

3. The electrical machine of claim 1, wherein the rotor forms an air duct that extends in a radial direction and is configured to provide the air flow, and
wherein the air duct extends from a rotor shaft of the rotor in the radial direction and ends in the air gap at a radial outer end of the air duct.

4. The electrical machine of claim 3, wherein the air duct has an air supply adjacent to the rotor shaft and is provided by at least one opening.

5. The electrical machine of claim 3, wherein the rotor shaft is a hollow shaft,
wherein the hollow shaft is connected to the air duct via at least one opening, and
wherein the air flow is provided by air which is configured to flow from the hollow shaft into the air duct.

6. The electrical machine of claim 3, wherein the air duct is provided by two radially oriented plates spaced apart from each other in the axial direction.

7. The electrical machine of claim 3, further comprising:
a support structure in which the air duct is formed,
wherein a radially outer end of the support structure, which is remote from the rotor shaft, comprises at least one receiving surface configured to receive at least one external permanent magnet.

8. The electrical machine of claim 3, further comprising:
elements arranged in the air duct that are configured to convey the air flow.

9. The electrical machine of claim 3, wherein the air duct ends in a center of the air gap in relation to an axial extent of the air gap.

10. The electrical machine of claim 7, wherein the support structure has a T-shaped design in longitudinal section of the rotor.

11. The electrical machine of claim 3, wherein the cylindrical inner surface of the stator forms a structure that is wedge-shaped in a longitudinal section in a region in which air exiting from the air duct extending in the radial direction strikes the stator and which deflects a portion of the air axially forward and a portion of the air axially backward.

12. The electrical machine of claim 1, further comprising:
a seal is provided axially in front of the air gap and/or axially behind the air gap,
wherein the seal is configured to seal off the air gap against contaminants.

13. The electrical machine of claim 12, wherein the seal extends radially inward starting from the stator and protrudes radially inward over the air gap.

14. The electrical machine of claim 12, wherein the seal is a mechanical seal, a labyrinth seal, or a brush seal.

15. The electrical machine of claim 1, wherein the electrical machine is a permanent-magnet synchronous motor.

16. A method for cleaning an air gap in an electrical machine, wherein the air gap extends between a cylindrical inner surface of a stator and a cylindrical outer surface of a rotor of the electrical machine, the method comprising:
accelerating air in radial direction of the electrical machine by rotating the rotor;
flowing the air into the air gap of the electrical machine; and
flowing the air in an axial direction and/or counter to the axial direction of the rotor in the air gap, therein cleaning the air gap in the electrical machine.

17. The method of claim 16, wherein the air is accelerated in an air duct that extends in the rotor in the radial direction and ends in the air gap.
